(19) United States
(12) Patent Application Publication
(10) Pub. No.: US 2006/0153208 A1
(43) Pub. Date: Jul. 13, 2006

(54) Discovery, deployment, and security systems and methods

(76) Inventor: Francis P. Costanzo, Austin, TX (US)

Correspondence Address: H. DALE LANGLEY, JR.;THE LAW FIRM OF H. DALE LANGLEY, JR. PC, 610 WEST LYNN, AUSTIN, TX, 78703, US

(21) Appl. No.: 11/295,011

(22) Filed: Dec. 6, 2005

Related U.S. Application Data
(60) Provisional application No. 60/643,099, filed on Jan. 11, 2005.

(51) Int. Cl. H04L 12/56

(52) U.S. Cl. 370/401; 370/352

(57) ABSTRACT

A system and method for discovering devices connected to a communications network, such as the Internet, includes an agent and installation of the agent on a communications device of the network. The agent is installed on a delegate device, which may, but need not necessarily, be an administration device for the network. The delegate device discovers all other devices of the network, via the agent. The agent is also installed on each other networked device, either by direct installation or by pushing the agent to each other device by communications over the network from the delegate device after discovery. The delegate device, which may be the same device that discovers or another device so designated by delegation, deploys the agent on the other devices, including by delegating authority and capabilities to dictate operations by the other devices. The delegate device can delegate to each other device the ability to discover other networked devices, or not, and also can delegate other functions of the agent once deployed on the other devices. The delegate device (or devices, as the case may be), and the other devices on which are deployed the agent, are linked in communication over the network, for example, to communicate via TCP/IP protocols. The agent of the delegate device controls by delegation to the agent of the other devices, the permissible operations of the agent on the other devices. The agent of each device can be delegated authority and capability, by communications from the delegate device (which may, but need not necessarily be, an administration device for the network), to automatedly or otherwise download software patches and perform security compliance operations at each device.

### BACKGROUND OF THE INVENTION

The present invention generally relates to communications network management systems and methods and, more particularly, relates to device and operations detection and discovery, deployment of devices, components, softwares, utilities and operations, and security of communications, data and operations and methods for system management of the communications networks, such as, for example, computer and device networks of a company or enterprise.

In communications networks, administrators and managers typically spend much time installing components and devices, setting-up and configuring administration and networking operations for the components and devices, upgrading and maintenance of devices, components and softwares, utilities and operations thereof, and securing and ensuring security of the network, communications and devices. Efforts have been made to automate certain of the functions performed in administrating and managing these networks. The conventional efforts have been problematic because of difficulties of set-up and configuration, direct manpower and efforts required at each device and component for upgrade and maintenance, and security concerns in distributing softwares and upgrades and in communications on the networks generally.

Typically, these communications networks include, for example, server computers, desktop computers, laptops, personal digital assistants, cellular phone/processing devices, peripherals such as displays, input devices, media devices, storage, printers and others, and a multitude of other possible networked or networkable devices. The networked devices in these communications networks can be interconnected by wire, wireless, and other communication links. The various devices can be local, such as within a single office or building, or, as is often the case, are widely distributed throughout several geographic regions. Devices can even be located internationally, can be fixed or mobile in location, and can otherwise be widespread and diverse in location and communicative operations.

A variety of protocols and technologies are employed in communications networks. Currently, a predominant networking technology operates in accordance with Transmission Control Protocol/Internet Protocol (TCP/IP). The public Internet also operates in accordance with TCP/IP protocols and technologies. Communications networks operating in accordance with TCP/IP, therefore, can include communicative elements located in virtually any and all geographic locations where the Internet is available. Such widespread communicative elements of communications networks makes problematic and time-intensive efforts of management, administration and supervision of devices and connectivity, upgrade and maintenance including software and operation deployments, and security of the individual components and of the entire networks.

It would be a significant improvement in the art and technology to provide centralized management, administration, and maintenance systems and methods for communications networks, and particularly, to incorporate device and component discovery, for configuration and operations of the disparate devices and elements of such networks. Additionally, it would be a significant improvement to automate much of the deployment of upgrades, maintenance and other operational aspects of the devices and elements of such networks. Moreover, it would be a significant improvement in the art and technology to secure these operations and the operations of devices and elements of the networks. Because the Internet is a readily available path for network communications, it would be a significant improvement and advance in the art and technology to provide these discovery, deployment and security functions via the Internet or other wide area networks. The present invention provides these and numerous other advantages and improvements for widespread networks of communication devices, including connected computers and other devices.

### SUMMARY OF THE INVENTION

An embodiment of the invention is an agent for a first communicative device. The first communicative device is communicatively connected to a network including a second communicative device. The agent includes a discoverer, connected to the first communicative device, for identifying the second communicative device on the network, a log, connected to the first communicating device, for retaining identification of the second communicative device, and a delegator connected to the first communicative device, for designating authority and capability of the first communicative device with respect to control of the second communicative device, and vice versa.

Another embodiment of the invention is a method of discovering a second device of a communications network. The method operates on a first device of the communications network. The method includes installing an agent on the first device and discovering an identifier of the second device, by communications activated by the agent from the first device over the network.

Yet another embodiment of the invention is a method of discovering and deploying. The method operates on a first device communicatively connected to a communications network including a second device communicatively connected to the network. The method includes installing an agent on the first device and the second device, pinging by the first device via communications over the network by the first device to the second device, via an identifier of the second device, connecting on a port of the second device, by communications over the network from the first device to the second device, and communicatively linking the second device and the first device for communications over the network according to a TCP/IP protocol.

### BRIEF DESCRIPTION OF THE DRAWINGS

The present invention is illustrated by way of example and not limitation in the accompanying figures, in which like references indicate similar elements, and in which:

FIG. 1 illustrates a discovery, deployment and security system, including multiple client devices and an administrator device, communicatively connected by a communications network, such as the Internet, for administrator and client discovery of other network-connected devices and for administrator deployment, security compliance and other control and maintenance of the client devices over and through communications on the network, according to certain embodiments;

FIG. 2 illustrates a client computer, including an agent, and an administrator computer, also including an agent, for discovery, deployment, and security compliance operations through communications over and through a network, each computer being communicatively connected by the network, and the administrator computer being delegated to deploy to the client computer the agent, the client computer and the administrator computer each being capable of discovery of other network-connected devices, and the administrator computer being delegated to operate and ensure security compliance of the client computer, by and through network communications, according to certain embodiments;

FIG. 3 illustrates a discovery, deployment and security system, including a client device (or more than one), an administrator device, and another device that is designated as a delegate device, each communicatively connected by a communications network, such as the Internet, for delegate discovery of other network-connected devices and for deployment, security compliance and other control and maintenance of the client devices (and any applicable administrator device that is not the delegate device) over and through communications on the network, according to certain embodiments;

FIG. 4 illustrates a delegate computer, including an agent (where the delegate computer is any device, and/or could be a client computer, administrator computer, or other device of the network, including combinations thereof), a client device (or more than one), and an administrator computer, wherein the delegate computer has discovered and deployed the agent, and can perform security compliance operations on, each computer communicatively connected to the network and having the agent, all through communications over and through a network, where, for example, the delegate computer deploys to the client computer the agent, the client computer is capable of discovery of other network-connected devices, and the delegate computer is delegated to operate and ensure security compliance of the client computer via the agent of the client computer and the agent of the delegate computer, by and through network communications, according to certain embodiments;

FIG. 5 illustrates a method of discovery, operable in a client computer and an administrator computer, each computer including an operating system, communication applications programs, and a log memory, and also each computer either being installed with pursuant to the method or otherwise including an agent, wherein the respective agents enable discovery operations by and through network communications, according to certain embodiments;

FIG. 6 illustrates a method of deployment, operable via the agent of the administrator computer, wherein the administrator computer is delegated authority and capability to make deployment to client computer having the agent and communicatively connected to the administrator computer by and through a network and network communications between the devices, according to certain embodiments; and

FIG. 7 illustrates an example system, including an Internet network, communicatively connecting two administrators (which may be delegates) and two clients, for operations of discovery, deployment and security compliance by and through communications between administrators and clients over the network, according to certain embodiments of the invention.

### DETAILED DESCRIPTION

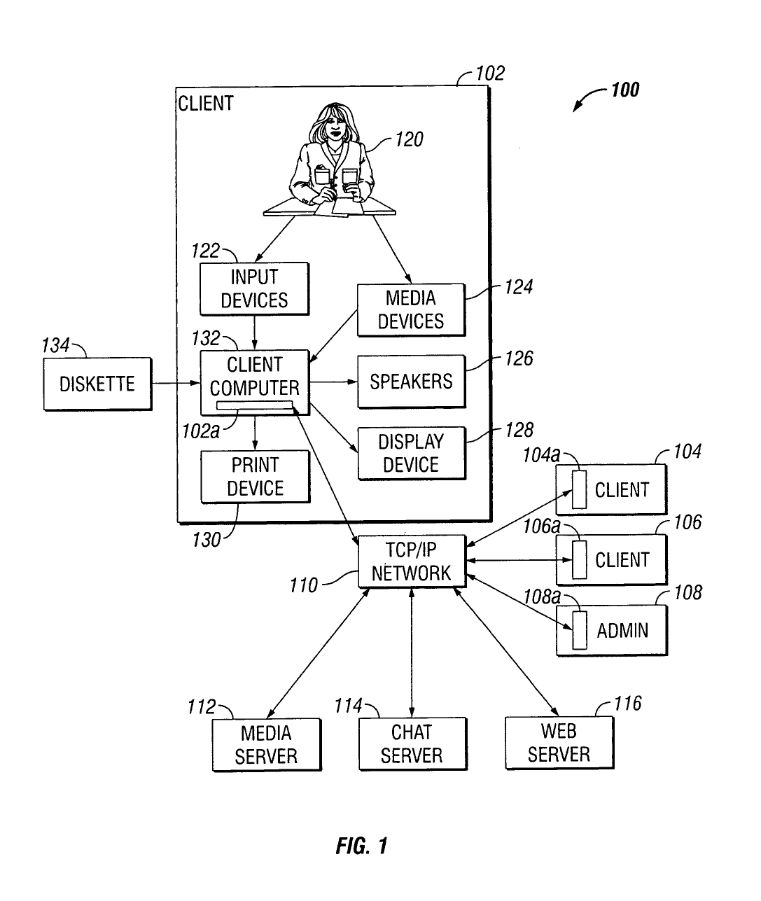

Referring to FIG. 1, a computer network management system 100 includes a communications network 110, such as a Transmission Control Protocol/Internet Protocol (TCP/IP) or other networking protocol-based network. The network 110 communicatively connects servers 112, 114 and 116 to each of clients 102, 104, and 106 and to an administrator 108. Each of the clients 102, 104, 106 is installed with a respective agent 102a, 104a, 106a. The administrator 108 is also installed with an agent 108a. The agents 102a, 104a, 106a, 108a are substantially identical, as hereafter detailed.

Through the network 110, data is communicable by and between the servers 112, 114 and 116, and the clients 102, 104, 106 and the administrator 108, each to the other. The network 110 comprises wired, wireless, optical, Wi-Fi, WAN, LAN, any other possible communicative connections, channels, or links, and single ones or combinations thereof. The agents 102a, 104a, 106a, 108a are capable of respective push and pull operations as to data, connectivity, communications, and information passed between the respective clients 102, 104, 106 and administrator 108, each to and from the other.

The clients 102, 104, 106 and the administrator 108 are each substantially identical, for purposes of the description herein, in that each is capable of communicative connection to and with the network 110, in at least one of any of the various possible communicative connections of and to the network 110. For example, clients 102, 104, 106 and the administrator 108 can each be any of a personal or desktop computer, notebook computer, personal digital assistant, cellular telephone, or any of a variety of other communicative or processing devices or systems of such devices. The client 102 is representative of each of the clients 102, 104, 106 and the administrator 108, for purposes of the description herein.

The client 102 includes, for example, a communicative component (e.g., a modem, a network card, a cellular link, an 802.11 link, or any other communicative link to the network 110) for performing transmissions and receptions of data to, from and over the network 110. The client 102 can also have a user 120 of the client 102, such as a human operator or another controlling device or application. The client 102, as is typical, can also include various peripherals and other components, such as, for example, input devices 122, media devices 124, speakers 126, a display device 128, a print device 130, a computer 132, a storage device 134, and other elements and functional components.

The computer 132 is installed with the agent 102a. Further, in the example of the client 102, the computer 132 is connected to the input devices 122, the media devices 124, the speakers 126, the display device 128, the print device 130, and the storage device 134. The display device 128 is, for example, a conventional electronic cathode ray tube, a flat-panel display, a separate computer or device, and any other of a wide possibility of components and elements that permit display either to the user 120 or to another device or application, as the case may be. The print device 130 is, for example, a conventional electronic printer or plotter. The storage device 134 is, for example, a hard drive, RAM, ROM, or any other digital or analog storage system or device.

In operation, the user 120 operates and controls the operations of the computer 132. The agent 132 operates on and with the computer 132, as hereinafter described. The input and output and other elements of the computer can control and operate the agent 132 or such elements can be controlled and operated by the agent 132, according to user-designated or delegated features or programmed features of the agent 132 and the computer 132 for and with the agent 132. Further, the administrator 108, via the agent 108a and otherwise, can designate or delegate or program features of the clients 102, 104, 106 via the respective agent 102a, 104a, 106a thereof, according to accessibility and control features and settings of the clients 102, 104, 106.

The computer 132, of each of the clients 102, 104, 106 and the administrator 108, can each perform various other functions and operations, for example, in response to signals from the computer 132, the display device 128 displays visual images, and the user 120 views such visual images. Also, in response to signals from the computer 132, the print device 130 can print visual images on paper, and the user 120 views such visual images. Further, in response to signals from the computer 132, the speakers 126 can output audio frequencies, and the user 120 listens to such audio frequencies. Moreover, the user 120 operates the input devices 122 and the media devices 124 in order to input information to the computer 132, and the computer 132 receives such information from the input devices 122 and the media devices 124.

The input devices 122 include, for example, a conventional electronic keyboard and a pointing device such as a conventional electronic “mouse”, rollerball, light pen, or other input function element. The user 120 operates the keyboard to input alphanumeric text information or other function or input information to the computer 132, and the computer 132 receives such information from the keyboard as so input. The user 120 further operates the pointing device to output cursor-control information to the computer 132, and the computer 132 receives such cursor-control information from the pointing device.

The user 120 operates the media devices 124 in order to output information to and output information from the computer 132 in the form of media signals, and the computer 132 receives or outputs such media signals to and from the media devices 124. The media signals include, for example, video signals and audio signals. The media devices 124 include, for example, a microphone, a video camera, a videocassette player, a CD-ROM (compact disc, read-only memory) player, a DVD (digital video) player, an electronic scanner device, and any other of a wide variety of possible input and output devices for media use and viewing/reception.

A network communications application, such as, for example, a web browser software application of the computer 132, is connected, via the client 102, to the network 110. The agent 102a operates in and in conjunction with the browser for purposes of enabling user-designation or delegation features or programmed features of the agent 102a and the computer 132 for and with the agent 102a. The client 102, comprising the agent 102a, is connected directly to the network 110, or through a local area network (LAN), a wide area network (WAN), or other communicative link, e.g., the communicative link can itself include various communicative links and connections including other networks or channels for connectivity. Via communicative connectivity to and from the network 110, the client 102, including operations of the agent 102a on the client 102, can transmit and receive from the network 110, for example, over the Internet, the World Wide Web (WWW), or other vehicle, protocol, standard, or proprietary mechanism. Of course, the administrator 108, being substantially identical to the client 102 except having additional control and access capabilities as to the client 102 and each other client, similarly operates via the agent 108a and web browser access.

Various other communicative devices and elements in addition to the client 102 are communicatively connected to and with the network 110, for communications to and from the client 102 over the network 110. Various servers, for example, the media server 112, the chat server 114, and the web server 116, are exemplary of devices connected to the network 110 and communicatively connected or connectable to the client 102. The media server 112, for example, serves media data to the client 102 upon appropriate communications to and from the client 102 and as dictated and enabled by the user 120 of the client 102. Similarly, the chat server 114 enables chat communications between the client 102 and the chat server 114, as dictated and enabled by the user 120 at the client 102. The web server 116 is any of a variety of server elements and communicative devices connected to the network 110, for communications of data and other information to and from the client 102 over the network 110. For example, the web server 116 is a server computer communicatively connected to the network 110 permitting communicative access by the web server 116 to the client 102 over the network 110 and permitting communicative access by the client 102 to the web server 116 over the network 110.

At least one administrator 108, having the agent 108a substantially identical to the agent 102a of the client 102, is similarly configured with the agent 108a, and all other functions, elements, and communicativity describe above with respect to the client 102. The administrator 108 differs from the clients 102, 104, 106 only in respect to the operational capabilities of the administrator 108 in accessing and setting features and security of the clients 102, 104, 106. The agent 108a of the administrator 108 is, in any event, substantially the same as the agents 102a, 104a, 106a of the clients 102, 104, 106, but generally with added system access, control, and setting features, including as to the clients 102, 104, 106.

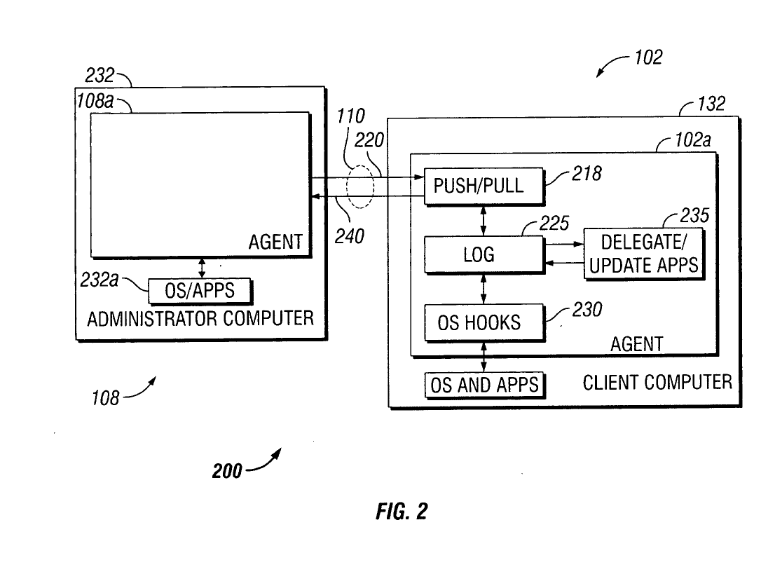

Referring to FIG. 2, a subset system 200 of the system 100 of FIG. 1, includes the client 102 and the administrator 108. The client 102 includes a client computer 132, and operating system and applications 132a of the computer 132. Additionally, the client includes the agent 102.

The administrator 108 of the system 200 includes an administrator computer 232. The computer 232 has an operating system and applications 232a. The agent 108a, substantially the same as the agent 102a, is also included in the administrator 108 and its computer 232.

The client 102 and the administrator 108 are communicatively connected by the network 110. The network 110 transfers communications signals 240 to travel from the client 102 to the administrator 108, and communications signals 220 to travel from the administrator 108 to the client 102. The agent 102a of the client 102, and the agent 108a of the administrator 108, communicatively connect via the respective devices and the network 110.

The agent 102a comprises a pusher/puller 218. The pusher/puller 218 is connected to a log 225 of the agent 102a. The log 225 is connected to a delegater/updater 235 of the agent 102a. Operating system hooks 230 of the agent 102a are connected to the log 225. The pusher/puller 218 connects to communicative devices of the computer 132.

The agent 108a has substantially similar features and operations to the agent 102a. The agent 108a, however, has access to the agent 102a and client 102 in order to control and dictate certain operations of the client 102 by the administrator 108. The client 102, on the other hand, has settings and designations of the agent 102a and other features of the client 102, that limit the operations of the client 102 in these respects.

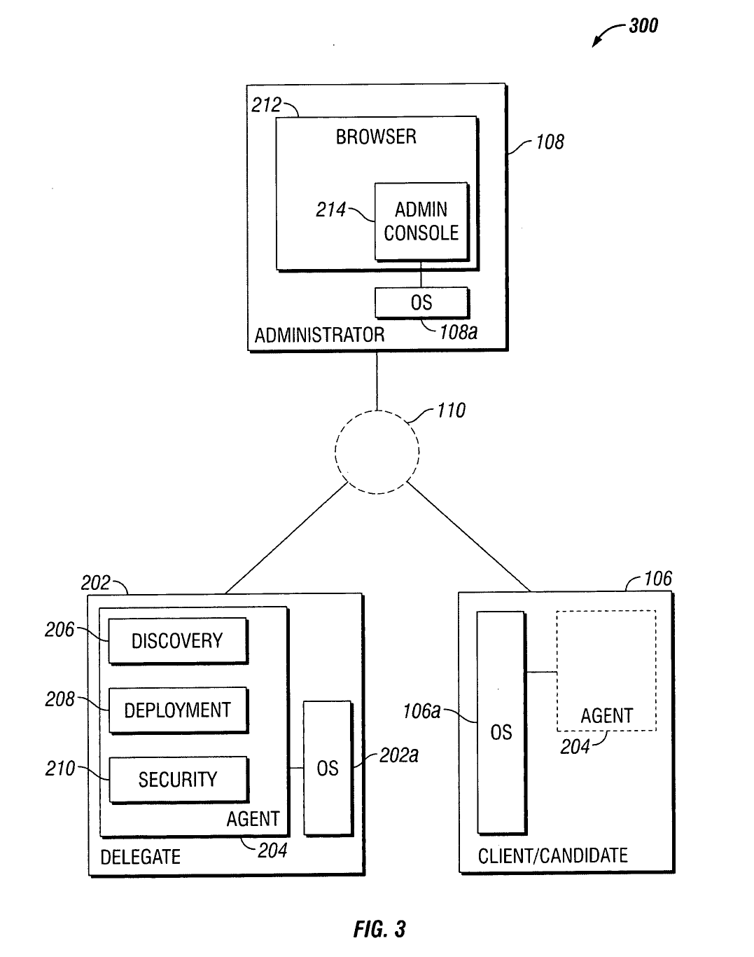

Referring to FIG. 3, a system 300 is an embodiment of the systems 100, 200 of FIGS. 1 and 2. In the system 300, the administrator 108 includes a processor and operating system 108a operating thereon. The administrator 108 also includes a network browser 212, such as Internet Explorer, Netscape, or other browser application, that operates on the administrator 108 with the processor and operating system 108a. The browser 212 accesses and displays an administrative console 214. The administrative console 214 is a user-interface application at the administrator 108, that allows configuration, information, and variables for operations of the system 300, including other client computers and agents thereon as hereinbefore described and as hereinafter further detailed.

The administrator 108 is connected, via the communications network 110, to at least two other client devices, for example, the client 106 and another client (such as client 102, 104, 106 of FIG. 1 or any other), a delegate 202, which is given delegation authority as hereinafter described. The administrator 108 or any client 102, 104, 106, etc. can be assigned as the delegate 202. In any event, the delegate 202 is communicatively connected to other devices of and via the network 110, and includes certain features in the embodiment of the system 300. In the system 300, the delegate 202 has been designated, but the client device 106 (and other connected client devices of the network, if any, although not shown in FIG. 3) has not yet been deployed with any agent 204 (shown in phantom to indicate that only the delegate 202 has been designated and the operations of the delegate 202 in discovering, deploying and securing as to the client 106 has not yet occurred).

The delegate 202, in particular, includes a processor and operating system 202a operating on the delegate 202. As previously mentioned, the delegate 202 can be any client device of the network 110, including the administrator 108 or any other device. The delegate 202 includes the agent 204. The agent 204 is loaded and installed on the delegate 202, either manually or in other manners, wherein the loading and installation on the delegate 202 is the first instance of the agent 204 on the system 300.

The agent 204 of the delegate 202 is communicatively connected to the operating system 202a of the delegate 202, for example, by hooks of the agent 204 into certain aspects, events, or instances of the operating system 202a and processor of the delegate and their operation on the delegate 202. The agent 204 includes three modules: a discovery module 206, a deployment module 208 and a security module 210. Each of these modules 206, 208, 210 are part of the agent 204 and operate within the agent 204 in conjunction with the hooking and interaction of the agent 204 with the operating system 202a and processor of the delegate 202.

In the system 300, the administrator 108, via the administrator console 214 through the browser 212 and its operation with the operating system 018a of the administrator 108, has various functions of administering operations of devices connected to the network 110 and of the network 110 and communications thereon. The administrator 108 communicates with the delegate 202 and the client 106, in order to allow viewing of conditions and variable inputs via the administrator console 214. For example, the administrator 108 may, but need not necessarily, control or make designation of itself or any other particular device connected to the network as being the delegate 202. Nonetheless, in the embodiment of the system 300, the delegate 202 has been established, by the administrator 108 or otherwise, and then the delegate 202 can operate on the network and connected devices for discovery, deployment and security functions. The delegate 202 includes the agent 204 in the embodiment in system 300, however, the agent 204 has not yet performed any functions (e.g., discovery, deployment, and/or security) with respect to the network 110 or other devices connected to the network 110, such as the client 106.

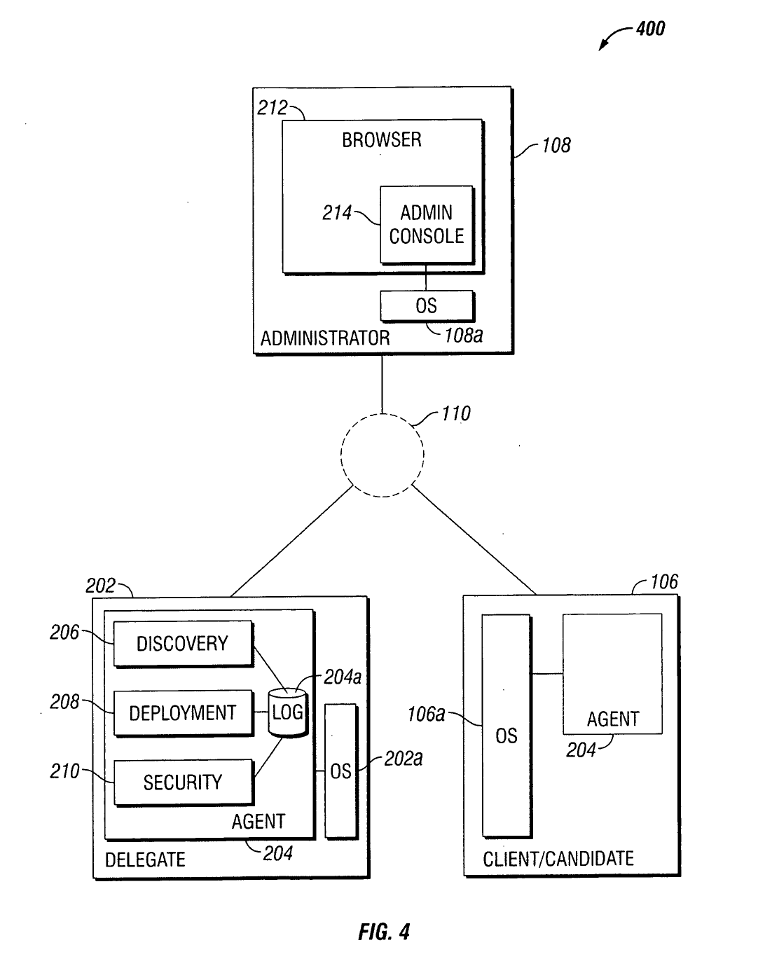

Referring to FIG. 4, the system 400 illustrates a state of the system 300 after the agent 204 of the delegate 202 has discovered the client 106, has deployed the agent 204 to the client 106, and then serves in securing as to the client 106 as hereinafter further described. The agent 204 of the delegate 202 additionally includes, accesses and/or otherwise maintains or keeps a log 204a. The log 204a is, for example, a database including historical records of actions performed by the discovery module 206, the deployment module 208, and/or the security module 210 of the agent 204 of the delegate 202.

In operations of the system 300, the delegate 202 via operations of the agent 204 discovers other devices of the network 110 by operations of the discovery module 206. The agent 204 then can deploy an agent application by operations of the deployment module 208, which, as previously discussed, can be the same as or substantially the same as the agent 204 but without delegated authority to operate to discover, deploy, and/or secure as performed by the delegate 202 (although certain authority in these functions could be delegated to more than one or even different devices as to the functions).

In the operations of system 400, the delegate 202 via operations of the agent 204 and its discovery module 206 and then deployment module 208, has discovered the client 106 and deployed the agent 204 on the client 106. Similar operations can occur, via the delegate 202 and each client 106, etc., communicatively connected to the network 110. Operations of the agent 204 in these systems 100, 200, 300, 400 of respective FIGS. 1, 2, 3 and 4 are exemplary, and it is to be understood that the particular network and devices communicating thereon can be widely varied in set-up and identity.

In sum, FIGS. 1 and 2 show an embodiment in which the administrator 108 is the delegate 202, and FIGS. 3 and 4 show an embodiment in which some other device, such as client 104 (renamed 202 in FIGS. 3 and 4, because designated as the delegate 202), of the network includes the agent 204 (as applicable).

Discovery

Referring back to FIGS. 1 and 2, but with the understanding that the operations can be implemented as in FIGS. 3 and 4 and otherwise, each of the client 102 and the administrator 108 (or the delegate 202, as applicable in the system), via the respective agents 102a, 108a (such as on the delegate 202, if the client 108 is the delegate 202, as applicable in the system), can search the network 110 to find other computers, devices and resources communicably connected to the network 110. The administrator 108 (or other delegate 202, as applicable), via the agent 102a (or other agent 204 of another delegate 202, if applicable), is automatically capable of discovering the other networked devices, including the client 102. The client 102, however, must be delegated the ability, by the administrator 108 (or other delegate 202, as applicable) in communications with the client 102 or by settings at the client 102, in order for the client 102 to be capable of discovering other networked devices. Particularly, the agent 108a of the administrator 108 (or, as applicable, agent 204 of another delegate 202) performs the discovery function. The agent 102a of the client 102 can likewise perform the discovery function, but only if the administrator 108 via the agent 108a (or, if applicable, agent 204 of another delegate 202) delegates to the client 102 via the agent 102a the capability or if the client 102 settings for the agent 102a enable such capability.

Hereinafter references to administrator 108 and agent 108a should be considered as being any delegate 202 and agent 204, which may include the administrator 108 and agent 108a of FIGS. 1 and 2 if the administrator 108 is so designated as the delegate 202. For clarity, however, the remaining discussion addresses the situation in which the administrator 108 and its agent 108a are the delegate 202 and agent 204; although it is to be understood that this is not necessarily the requirement of the embodiments, and that any device (any other client or the administrator or any other device) could instead be the delegate 202 and agent 204, as desired according to the system arrangement.

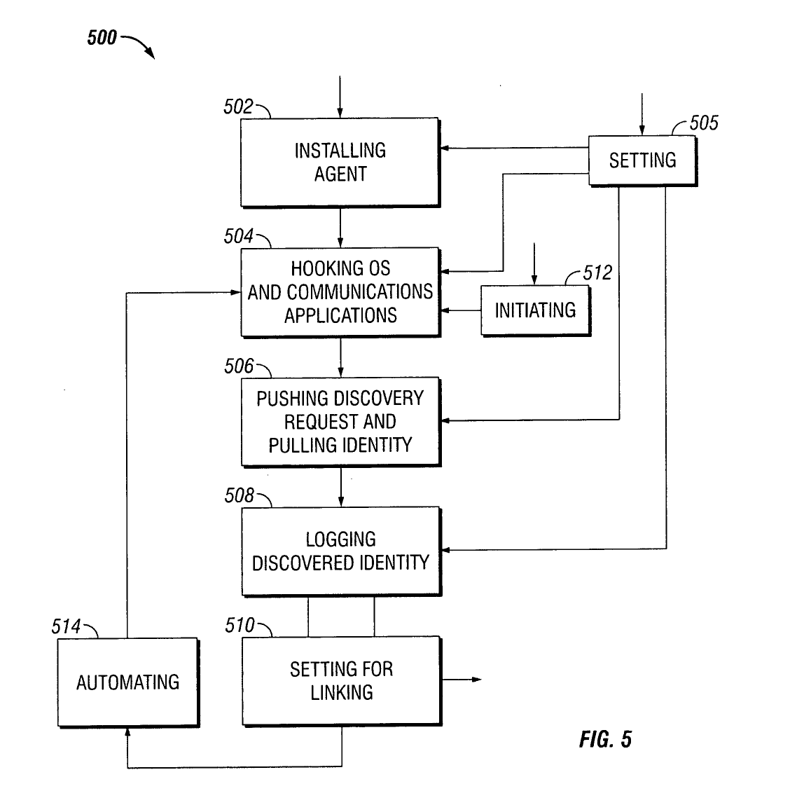

Referring to FIG. 5, a method 500 of operation of the administrator 108 (or delegate 202 as the case may be) and its agent 108a (or 204, if another is the delegate 202), and the client 102 client agent 102a if the capability has been delegated to the client 108, discovers other networked devices communicably connected to the network 110. In a step 302, the agent 102a or 108a is installed on a computer, such as the client computer 102 or the administrator computer 108 (or any other device that is designated as the delegate 202). In the step 502 (or, alternatively, through menu access on completion of the step 502, from time to time according to desired capabilities for the particular computer), a step 505 of setting permits a user or other controller to designate certain capabilities for the agent 102a. For example, if the agent 102a is desired solely to allow the client 102 to discover other networked devices, but not to administer or change settings on those devices, then the agent 102a is set in the step to discover other devices but not to change the other devices. If the agent 108a is, instead, desired to administer other networked client devices that are like the client 102, then the agent 108a is set with unrestricted capability as to discovery of client devices communicably connected to the network 110.

The method 500 continues in a step 504 of hooking (i.e., accessing or detecting an operating system event of the client 102) by the agent 102a to communications and operating system applications of the computer 132. The step 505 of setting can also be employed to set additional or different parameters for discovery and other operations of the agent 102a. Thereafter, in a step 506, the agent 102a communicates over the network by pushing discovery requests from the client 102 to the other communicatively connected devices of the network. If the request identifies a connected device of the network that also has the agent 102a or 108a, whether a client 102 or administrator 108, respectively, then the agent 102a of the client 102 determines an identification of the device in the step 506. The step 506 can comprise any of a wide variety of protocols and discovery communications capabilities and functions, for example, a discovery range or IP numbers of devices or other identifiers of devices can be prompted, a ping communication as the push can be according to ICMP, a connection is then made on a port of a located device of the range from the ping response, and then a TCP/IP or other link is established on a port of the located device. The step 505 can include setting of designations and delegation in connection with the step 506.

Upon discovery and identification of a networked device in the step 506, the agent 102a performs a step 508 of logging and identity of the discovered device. Thereafter, the agent 102a in a step 510, in conjunction with the computer 132 and its operating system and applications, sets up applicable data and information, including networking parameters, for communication linking of the client 102, via the agent 102a, to the discovered device also having the agent. The step 505 can include setting of data and designations for the agent 102a and client 102, generally, in connection with the step 508 of logging.

The steps 504, 506, 508, 510 can be automated, such that discovery of networked devices is performed at intervals or on occurrence of particular states at the client 102 or the network 110. The step 514 shows this automating. Additionally or alternatively, the steps 504, 506, 508, 510 can be initiated in a step 512 by other mechanisms, including, for example, on input of a user of the client 102 or on control of the client 102 or by the client 102 according to programming.

Although the method 500 has been described primarily as occurring on the client 102, substantially the same method 300 is performed by the administrator 108 and its agent 108a (or any other delegate 202 and its agent 204). The agent 108a may be set and programmed in order to allow the administrator 108 to access and otherwise control and change states of multiple clients, each having a client agent, over the network 110. The administrator 108, in a usual administration operations environment and setup, will regularly perform the method 500 to discover new and added client devices having the agent installed thereon. The discovery by the agent 102a, 108a can include identity of communicatively networked domains, WINS servers, IP addresses within ranges, and other identifiers and communication elements of the network.

Deployment

Referring back to FIG. 2 (and including FIG. 4, as to the delegate 202 and agent 204, in the illustrative embodiment therein), the administrator 108, via the agent 108a (or any other delegate 202 and its agent 204), can deploy the agent 102a to each discovered client device 102 of the network 110. The agent 102a, once so deployed (or otherwise installed) on the client 102, then enables the administrator 108 via the agent 108a to communicate designations and settings for the agent 102a on the client 102. Upon deployment (or other installation) of the agent 102a on the client 102, the client 102 operates the agent 102a on the client computer 132, in conjunction with the operating system and applications of the computer 132.

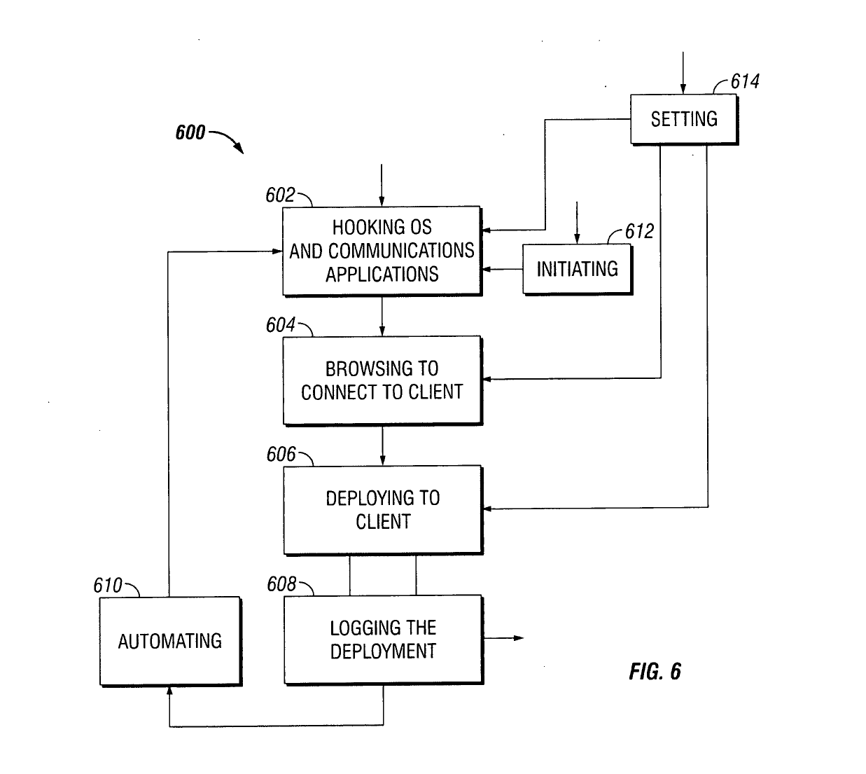

Referring to FIG. 6, a method 600 of deploying to the client 102 an application, setting, delegation, or other information or operation, is performed by the administrator 108, via the agent 108a (or other delegate 202 via the agent 204, as applicable), with the agent 102a of the client 102. Because the administrator 108 (or other delegate 202) will, in the usual configuration and arrangement, have control authority as to the client devices of the network, the method 600 includes the steps performed by the administrator 108 (or other delegate 202) in deploying to the client 102. Of course, because the agent 102a of the client 102 is substantially similar to the agent 108a of the administrator 108 (or 204 of 202), varying only by the particular delegated authority and capabilities of the agent 102a, the client 102 can act as the administrator 108 (i.e., as delegate 202) if settings and delegations therefore are permitted according to design and programming of the particular network and arrangement. The method 600 is described with respect to the administrator 108 (as though the administrator 108 is the delegate 202, although the delegate 202 could be some other device so designated), as this is the usual scenario.

In the method 600, a step 602 of hooking the operating system and applicable communications applications of the administrator 108, performed by the agent 108a, initiates transmissions by the administrator 108 to the client 102 over the network 110. The agent 108a of the administrator 108 then, in a step 604, runs a browser and connects the browser to the client 102 via the agent 102a. The browsing step 604 displays at the administrator 108 the connected devices and lists details of the each of the respective devices of the network, including, for example, information regarding device operations, state, designations, identity, and other network identification, usage, and state information.

A next step 606 of deploying includes transmission to the client 102, via the agent 108a of the administrator 108 to the agent 102a of the client 102 over the network, an information, application, setting or other data. After the step 606, a determination is made of successful completion of the step 606 and the deployment is logged in a step 608 of logging at the administrator 108. The administrator 108 retains and maintains the state of deployment as to each networked device.

The steps 602, 604, 606 are controlled in a step 614 of setting parameters and data at the administrator 108 and its agent 108a (or, of course, another delegate 202 and its agent 204, as applicable). The steps 602, 604, 606, 608 can be automated in a step 610, such as to perform the method 600 at particular intervals, occurrences or states determined by the administrator 108. Alternatively or additionally, a user or controller of the administrator 108 can initiate the method 600 at the administrator in a step 612.

A particular deployment operation according to the systems 200 and 400 of FIGS. 2 and 4, and the method 600 of FIG. 6, relates to patching of operating system and applications programs and operations at the client devices of the network. Further description is next provided.

Security

Although deployment by the administrator 108 (or other delegate 202, as applicable) to clients 102 over the network can include a wide variety of possible applications, information, settings, delegation and other control and maintenance aspects for the clients 102, a particular deployment operation regards security compliance of clients 102. For example, in regard to Windows-based operating systems of client devices in a network, the Microsoft Baseline Security Analyzer and the Microsoft Software Update Service are operable on individual devices to identify security vulnerabilities and to update operating systems and applications with patches to avoid loss of security. However, in order to be operable on devices, the Analyzer and the Service must each be installed and deployed for operations on the devices.

The systems 100, 200, 300, 400 and methods 500, 600 permit deployment and operations of these and other security applications and services on clients 102 of the network 110, by the administrator 108 (or other delegate 202). This deployment and operations are possible because of the agent 108a of the administrator 108 (or, if applicable, the agent 204 of another delegate 202) and the respective agent 102a of each client 102. Particularly, after discovery of each networked device (either by client 102 or administrator 108 or other delegate 202, as the case may be) in accordance with the method 500, the administrator 108 (or other delegate 202) deploys in the method 600 each of the applications and services to and on the client 102.

In the case of the Analyzer, the agent 108a of the administrator 108 (or, if applicable, the agent 204 of the delegate 202) determines via communication of the agent 102a of any particular client 102, that the client 102 does not have the Analyzer installed on the client 102. The agent 108a of the administrator 108 (or other agent of delegate), then, either automatically or by control at the administrator 108 (according to settings and programming for the administrator 108), communicates the Analyzer to the client 102 and installs the Analyzer on the client 102 via the agent 102a. The administrator 108, through communications with the client 102, controls the client 102 to run the Analyzer at the client 102. Of course, the control can be by a user-administrator at the administrator 108 or can be programmed for automated operations at the administrator 108. Additionally, the administrator 108, in the communications, can set, change and otherwise affect states of the client 102 for running and use of the Analyzer at the client 102. All of this is possible because of the agent 108a and the agent 102a.

Likewise, the Microsoft Software Update Service can be deployed by the administrator 108 (or other delegate, as applicable) to each particular client 102, through operations of the agent 108a (or other agent of the delegate) and the agent 102a and communications over the network. As with other security and patch applications, the agent 108a of the administrator 108 either automatically, or by control at the administrator 108 (according to the settings and programming for the administrator 108), can deliver the Update Service application or patches to the client 102 and install them on the client 102 via operation of the agent 102a. The administrator 108 communicates with the client 102 to control the client 102 to install and run the Update Service at the client 102. The control by the administrator 108 is similar in this instance, in that the control can be by a user-administrator at the administrator 108 or can be programmed for automated operations at the administrator 108. Further, the administrator 108, in the communications, can set, change and otherwise affect states of the client 102 for running and use of the Update Service at the client 102, such as by setting an automatic update operation at a particular interval for the client 102 or other. The agent 108a and the agent 102a make this possible.

Numerous other discovery, deployment and security compliance activities, as well as other actions and operations, are possible through the agent 108a of the administrator 108 and the agent 102a of the client 102 by communications over the network. In all instances, references to the administrator 108 and agent 108a apply to any other delegate 202 and agent 204, as has been discussed and previously stated, according to the particular arrangement. Also, additional types and states of clients and administrators and operations, applications, and capabilities thereof, can be retained and maintained by administrators. Because the agent 102a and the agent 108a are similar, except for the authorizations and delegations made to dictate respective operations of the particular agent 102a, 108a, any client 102 can, by changing authorizations and delegations, serve as the administrator 108, and vice versa. Additionally, because discovery, deployment and security compliance operations directed at the administrator 108 are operational on the client 102 via the respective agents 102a, 108a, both client 102 and administrator 108 can perform the operations described herein as allowed or designated pursuant to desired authorizations and delegations.

A particularly desirable arrangement for the client 102 is that the client 102 has discovery capability, such that the client 102 can, itself, discover other connected devices including the administrator 108 (i.e., in this instance, for example, the client 102 is designated as delegate 202 via agent 204 to the extent of the discovery function only). Moreover, the arrangement prevents the client 102 from, itself, serving other administrator 108 functions of deployment and so forth. The administrator 108 (or other delegate), on the other hand, can also discover and includes additional capabilities of deployment, control, security and other aspects of the administrator 108 (or other delegate) and also clients 102.

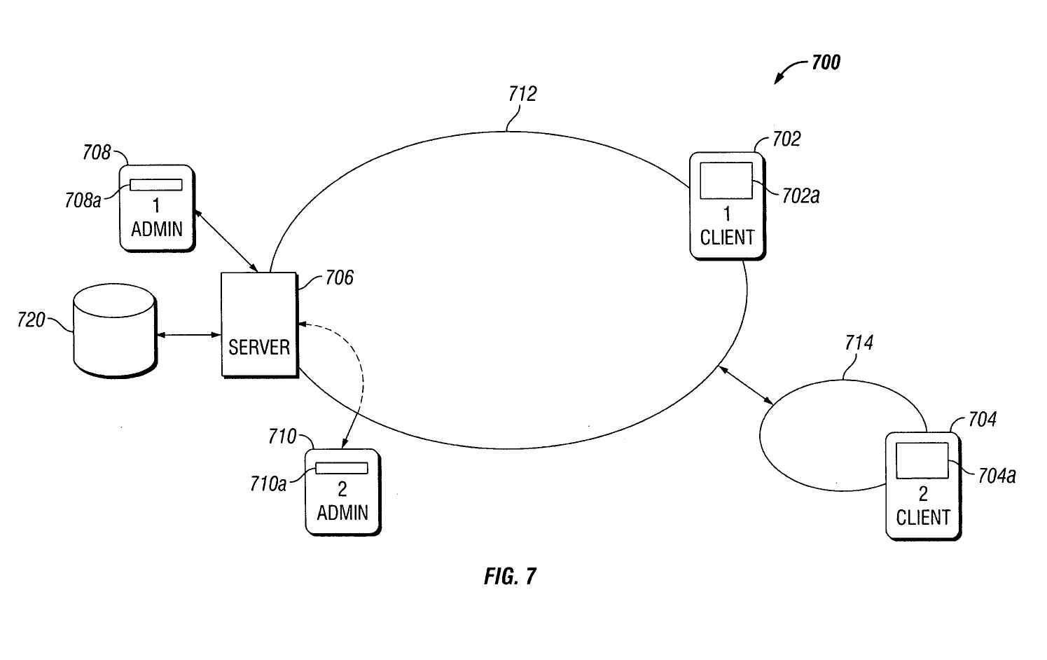

Referring to FIG. 7, another example system 700 in accordance with the foregoing, includes several administrators 708, 710 and several clients 702, 704. Each of the administrators 708, 710 is communicably connected to a network, such as the Internet 712. The administrator 708 is, for example, directly connected to a server 706 connected with database or other applications 720 and communicatively connected to the Internet 712. The administrator 710 is, for example, also communicably connected to the server 706, however, the location of the administrator 710 is remote from the server 706 and connects via the Internet 712 to the server 706 (e.g., through multiple links, servers, and other devices or otherwise).

Each of the clients 702, 704 is also communicably connected to the Internet 712. For example, the client 702 has a direct connection to the Internet 712, such as via a broadband link. The client 704, on the other hand, connects to the Internet 712 indirectly, such as through a LAN or WAN at the location of the client 704.

Each of the administrators 708, 710 and the clients 702, 704 includes an agent 708a, 710a, 702a, 704a, respectively, of the type previously described. Different delegations of authority and capabilities are set for the administrators 708, 710 (or any other delegates, as previously discussed) versus the clients 702, 704. However, as previously described, the delegations are dependent on desires for the arrangement and particular configuration in each instance, and are not dictated by or because of the agent itself. Nonetheless, in the usual configuration, the administrators 708, 710 are set and programmed to control discovery, deployment, security compliance and other operations of the clients 702, 704 via communications made by the administrators 708, 710 to the clients 702, 704 over the Internet 712. It is to be understood and intended that each separate client and administrator can have independent and particular delegations, as desired in the system 700 (e.g., any certain administrator or other delegate, as the case may be, may have different authority and capabilities than any other administrator or delegate, and the same applies as to respective clients and each client with respect to respective administrators and any other delegate). Moreover, the identifications of state of each administrator 708a, 710a, and client 702, 704, can be made by any authorized communicably connected device having the agent, by means of browser display by such device.

In all of the foregoing, references to “administrator” have been variously made in order to describe a typical embodiment, however, it is to be understood that whatever is referred to as “administrator” may or may not be the “delegate” for operations of the systems and methods herein; however, for purposes of anticipated actual embodiments of the systems and methods, an “administrator” may often also be the “delegate” for purposes of the operations—but, this is not the exclusive possibility. Interchangeability of the terms “administrator” and “delegate” as to the operations of the embodiments described herein, should thus be considered in the context indicated and with broadest construction of whether, when and if any administrator is also the delegate, and vice versa.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention.

Benefits, other advantages, and solutions to problems have been described above with regard to specific embodiments. However, the benefits, advantages, solutions to problems and any element(s) that may cause any benefit, advantage, or solution to occur or become more pronounced are not to be construed as a critical, required, or essential feature or element of any or all the claims. As used herein, the terms “comprises, “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. An agent for a first communicative device communicatively connected to a network including a second communicative device, comprising:
a discoverer, connected to the first communicative device, for identifying the second communicative device on the network;
a log, connected to the first communicating device, for retaining identification of the second communicative device;
a delegator connected to the first communicative device, for designating authority and capability of the first communicative device with respect to control of the second communicative device, and vice versa.

2. The agent of claim 1, wherein the agent includes the discoverer and the log.

3. The agent of claim 2, wherein the delegator is not included in the agent and communicates over the network to delegate to the first communicative device.

4. The agent of claim 3, wherein the first communicative device, as delegate, further comprises:
a deployer for deploying an agent to the second communicative device over the network.

5. The agent of claim 3, wherein the agent of the first communicative device includes the deployer.

6. The agent of claim 4, wherein the agent of the first communicative device, via communication to the second communicative device over the network, performs operations selected from the group consisting of: discovery of the second communicative device; deployment of an agent to the second communicative device; installation of an agent on the second communicative device; and removal of an agent from the second communicative device.

7. The agent of claim 5, wherein the deployer delivers a data via communication over the network, to the second communicative device, for control of the second communicative device.

8. The agent of claim 3, wherein the second device also comprises the agent and the delegator does not delegate to the agent of the second communicative device.

9. The agent of claim 1, further comprising:
a deployer, connected to the first communicating device, for deploying an information to the second communication device over the network.

10. The agent of claim 1, wherein the deployer delivers a data via communication over the network, to the second communicative device, for control of the second communicative device.

11. The agent of claim 3, further comprising:
a securer, connected to the first communicating device; and
wherein the securer performs a compliance scan of the second communicative device, for security compliance of the second communicative device.

12. The agent of claim 7, wherein the data is selected from the group consisting of: a software patch; and a software installation package.

13. A method of discovering a second device of a communications network, operating on a first device of the communications network, comprising the steps of:
installing an agent on the first device; and
discovering an identifier of the second device, by communications activated by the agent from the first device over the network.

14. The method of claim 13, further comprising the step of:
deploying the agent to the second device, by communications activated by the agent from the first device over the network to the second device.

15. The method of claim 14, further comprising the step of:
installing the agent on the second device; and
delegating an authority for the agent of the second device, by communications activated by the agent from the first device over the network to the second device.

16. The method of claim 15, further comprising the step of:
automating the steps.

17. The method of claim 14, further comprising the steps of:
installing the agent on the second device;
pushing a data to the second device, by communications activated by the agent from the first device over the network to the second device.

18. The method of claim 17, wherein the data is selected from the group consisting of: a security application, and a software patch.

19. The method of claim 17, wherein the agent on the first device is the same as the agent on the second device, and the agent on the second device is controlled by the first device, via communications activated by the agent from the first device over the network to the second device, by delegating a authority of discovering networked devices to the agent of the second device by communications of the second device over the network.

20. The method of claim 13, wherein the network is the Internet.

21. The method of claim 14, wherein the network is the Internet.

22. A method of discovering and deploying, operating on a first device communicatively connected to a communications network including a second device communicatively connected to the network, comprising the steps of:
installing an agent on the first device and the second device;
pinging by the first device via communications over the network by the first device to the second device, via an identifier of the second device;
connecting on a port of the second device, by communications over the network from the first device to the second device; and
communicatively linking the second device and the first device for communications over the network according to a TCP/IP protocol.

23. The method of claim 22, wherein the identifier is within a range of a set of identifiers for devices connectable to the network.

24. The method of claim 22, further comprising the step of:
deploying an update service on the second device, by communications over the network from the first device to the second device.

25. The method of claim 22, further comprising the step of:
deploying a software patch on the second device, by communications over the network from the first device to the second device.

26. The method of claim 22, wherein the network is the Internet.
